(19) United States
(12) Patent Application Publication
(10) Pub. No.: US 2006/0064253 A1
(43) Pub. Date: Mar. 23, 2006

(54) Multiple high-resolution serum proteomic features for ovarian cancer detection

(76) Inventors: Ben A. Hitt, Wheeling, WV (US); Peter J. Levine, Potomac, MD (US)

Correspondence Address: COOLEY GODWARD LLP;ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 11/093,018

(22) Filed: Mar. 30, 2005

Related U.S. Application Data
(63) Continuation of application No. 10/902,427, filed on Jul. 30, 2004, now abandoned.
(60) Provisional application No. 60/491,524, filed on Aug. 1, 2003.

(51) Int. Cl. G06F 19/00

(52) U.S. Cl. 702/22

(57) ABSTRACT

A well-controlled serum study set (n=248) from women being followed and evaluated for the presence of ovarian cancer was used to extend serum proteomic pattern analysis to a higher resolution mass spectrometer instrument platform to explore the existence of multiple distinct highly accurate diagnostic sets of features present in the same mass spectrum. Multiple highly accurate diagnostic proteomic feature sets exist within human sera mass spectra. Using high-resolution mass spectral data, at least 56 different patterns were discovered that achieve greater than 85% sensitivity and specificity in testing and validation. Four of those feature sets exhibited 100% sensitivity and specificity in blinded validation. The sensitivity and specificity of diagnostic models generated from high-resolution mass spectral data were superior (P<0.00001) than those generated from low-resolution mass spectral data using the same input sample.

### CROSS-REFERENCE TO RELATED APPLICATIONS

This application is a continuation of and claims priority under 35 U.S.C. sec. 120 of U.S. patent application Ser. No. 10/902,427, entitled “Multiple High-resolution Serum Proteomic Features for Ovarian Cancer Detection,” filed Jul. 30, 2004, the entire contents of which are hereby incorporated by reference, which claims benefit under 35 U.S.C. sec. 119(e)(1) to U.S. Provisional Patent Application Ser. No. 60/491,524, filed Aug. 1, 2003, and entitled “Multiple High-Resolution Serum Proteomic Features For Ovarian Cancer Detection,” the entire contents of which are hereby incorporated by reference. Additionally, this application claims benefit under 35 U.S.C. sec. 120 to U.S. patent application Ser. No. 09/906,661, entitled “A Process For Discriminating Between Biological States Based On Hidden Patterns From Biological Data,” filed on Jul. 18, 2001, the entirety of which is incorporated herein by reference, which claims benefit under 35 U.S.C. sec. 119(e)(1) to U.S. Provisional Patent Application Ser. No. 60/232,299, filed Sep. 12, 2000, U.S. Provisional Patent Application Ser. No. 60/278,550, filed Mar. 23, 2001, U.S. Provisional Patent Application Ser. No. 60/219,067, filed Jul. 18, 2000, and U.S. Provisional Patent Application Ser. No. 60/289,362, filed May 8, 2001.

### BACKGROUND

Serum proteomic pattern analysis by mass spectrometry (MS) is an emerging technology that is being used to identify biomarker disease profiles. Using this MS-based approach, the mass spectra generated from a training set of serum samples is analyzed by a bioinformatic algorithm to identify diagnostic signature patterns comprised of a subset of key mass-to-charge (m/z) species and their relative intensities. Mass spectra from unknown samples are subsequently classified by likeness to the pattern found in mass spectra used in the training set. The number of key m/z species whose combined relative intensities define the pattern represent a very small subset of the entire number of species present in any given serum mass spectrum.

The feasibility of using MS proteomic pattern analysis for the diagnosis of ovarian, breast, and prostate cancer has been demonstrated. While investigators have used a variety of different bioinformatic algorithms for pattern discovery, the most common analytical platform is comprised of a low-resolution time-of-flight (TOF) mass spectrometer where samples are ionized by surface enhanced laser desorption/ionization (SELDI), a ProteinChip array-based chromatographic retention technology that allows for direct mass spectrometric analysis of analytes retained on the array.

Ovarian cancer is the leading cause of gynecological malignancy and is the fifth most common cause of cancer-related death in women. The American Cancer Society estimates that that there will be 23,300 new cases of ovarian cancer and 13,900 deaths in 2002. Unfortunately, almost 80% of women with common epithelial ovarian cancer are not diagnosed until the disease is advanced in stage, i.e., has spread to the upper abdomen (stage III) or beyond (stage IV). The 5-year survival rate for these women is only 15 to 20%, whereas the 5-year survival rate for ovarian cancer at stage I approaches 95% with surgical intervention. The early diagnosis of ovarian cancer, therefore, could dramatically decrease the number of deaths from this cancer.

The most widely used diagnostic biomarker for ovarian cancer is Cancer Antigen 125 (CA 125) as detected by the monoclonal antibody OC 125. Though 80% of patients with ovarian cancer possess elevated levels of CA 125, it is elevated in only 50-60% of patients at stage I, lending it a positive-predictive value of 10%. Moreover, CA 125 can be elevated in other non-gynecologic and benign conditions. A combined strategy of CA 125 determination with ultrasonography increases the positive-predictive value to approximately 20%.

Low molecular weight serum proteomic patterns from low-resolution SELDI-TOF MS data can distinguish neoplastic from non-neoplastic disease within the ovary. See Petricoin, E. F. III et al. Use of proteomic patterns in serum to identify ovarian cancer. The Lancet 359, 572-577 (2002). The proteomic patterns can be identified by application of an artificial intelligence bioinformatics tool that employs an unsupervised system (self-organizing cluster mapping) as a fitness test for a supervised system (a genetic algorithm). A training set comprised of SELDI-TOF mass spectra from serum derived from either unaffected women or women with ovarian cancer is employed so that the most fit combination of m/z features (along with their relative intensities) plotted in n-space can reliably distinguish the cohorts used in training. The “trained” algorithm is applied to a masked set of samples that resulted in a sensitivity of 100% and a specificity of 95%. This technique is described in more detail in WO 02/06829A2 “A Process for Discriminating Between Biological States Based on Hidden Patterns From Biological Data” (“Hidden Patterns”) the disclosure of which is hereby expressly incorporated herein by reference.

Although this technique works well, the low-resolution mass spectrometric instrumentation and thus the data that comes from the instrument may limit the attainable reproducibility, sensitivity, and specificity for proteomic pattern analyses for routine clinical use.

### SUMMARY

The protein pattern analysis concept of Hidden Patterns is extended to a high-resolution MS platform to generate diagnostic models possessing higher sensitivities and specificities on a format that generates more stable spectra, has a true time-of-flight mass accuracy, and is inherently more reproducible machine-to-machine and day-to-day because of the increase in mass accuracy. Sera from a large, well-controlled ovarian cancer screening trial were used and proteomic pattern analysis was conducted on the same samples on two mass spectral platforms differing in their effective resolution and mass accuracy. The data was analyzed so as to rank the sensitivity and specificity of the series of diagnostic models that emerged.

The spectra from a high-resolution and a low-resolution mass spectrometer with the same patients' sera samples applied and analyzed on the same SELDI ProteinChip arrays were compared. Although the higher resolution mass spectra may generate more distinguishable sets of diagnostic features, the increased complexity and dimensionality of data may reduce the likelihood of fruitful pattern discovery. Diagnostic proteomic feature sets can be discerned within the high-resolution spectra from the clinically relevant patient study set, and the modeling outcomes between the two instrument platforms can be compared. The number and character of the diagnostic models emerging from data mining operations can be ranked. Serum proteomic pattern analysis can be used for the generation of multiple, highly accurate models using a hybrid quadrupole time-of-flight (Qq-TOF) MS for an improved early diagnosis of ovarian cancer.

### BRIEF DESCRIPTION OF THE FIGURES

FIGS. 1A and 1B compare the mass spectra from control serum prepared on a WCX2 ProteinChip array and analyzed with a PBS-II TOF (panel A) or a Qq-TOF (panel B) mass spectrometer.

FIGS. 2A and 2B show histograms representing the testing results of sensitivity (2A) and specificity (2B) of 108 models for MS data acquired on either a Qq-TOF or a PBS-II TOF mass spectrometer.

FIGS. 3A and 3B show histograms representing the testing and blinded validation results of sensitivity (3A) and specificity (3B) of 108 models for MS data acquired on either a Qq-TOF or a PBS-II TOF mass spectrometer.

FIGS. 4A and 4B compare SELDI Qq-TOF mass spectra of serum from an unaffected individual (4A) and an ovarian cancer patient (4B).

### DETAILED DESCRIPTION

Analysis of Serum Samples

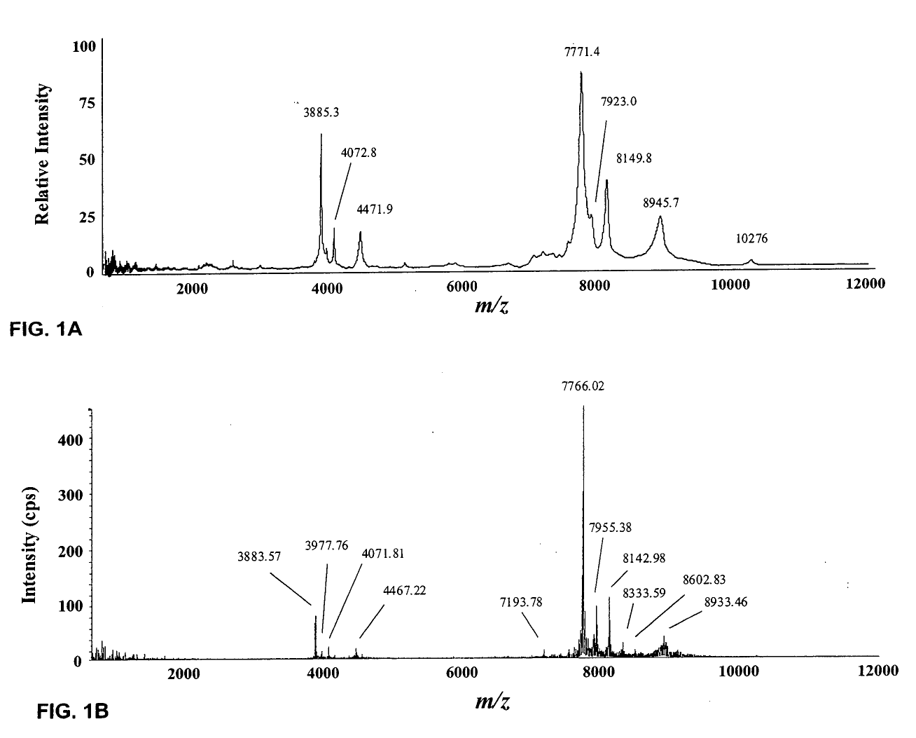

A total of 248 serum samples were provided from the National Ovarian Cancer Early Detection Program (NOCEDP) clinic at Northwestern University Hospital (Chicago, Ill.). The samples were processed and their proteomic patterns acquired by MS as described below in the description of the methods used. The serum samples in the present study were analyzed on the same protein chip arrays by both a PBS-II and a Qq-TOF MS fitted with a SELDI ProteinChip array interface. While the spectra acquired from both instruments are qualitatively similar, the higher resolution afforded by the Qq-TOF MS is apparent from FIG. 1. This increased resolution allows species close in m/z unresolved by the PBS-II TOF MS to be distinctly observed in the Qq-TOF mass spectrum. Indeed, simulations demonstrate the ability of the Qq-TOF MS (routine resolution ˜8000) to completely resolve species differing in m/z of only 0.375 (e.g., at m/z 3000) whereas complete resolution of species with the PBS-II TOF MS (routine resolution ˜150) is only possible for species that differ by m/z of 20 (simulation not shown).

The mass spectra were analyzed using the ProteomeQues™ bioinformatics tool employing ASCII files consisting of m/z and intensity values of either the PBS-II TOF or the Qq-TOF mass spectra as the input. The mass spectral data acquired using the Qq-TOF MS were binned to precisely define the number of features in each spectrum to 7,084 with each feature being comprised of a binned m/z and amplitude value. The algorithm examines the data to find a set of features at precise binned m/z values whose combined, normalized relative intensity values in n-space best segregate the data derived from the training set. Mass spectra acquired on the Qq-TOF and the PBS-II TOF instruments from the same sample sets were restricted to the m/z range from 700 to 11,893 for direct comparison between the two platforms. The entire set of spectra acquired from the serum samples was divided into three data sets: a) a training set that is used to discover the hidden diagnostics patterns, b) a testing set, and c) a validation set. With this approach only the normalized intensities of the key subset of m/z values identified using the training set were used to classify the testing and validation sets, and the algorithm had not previously “seen” the spectra in the testing and validation sets.

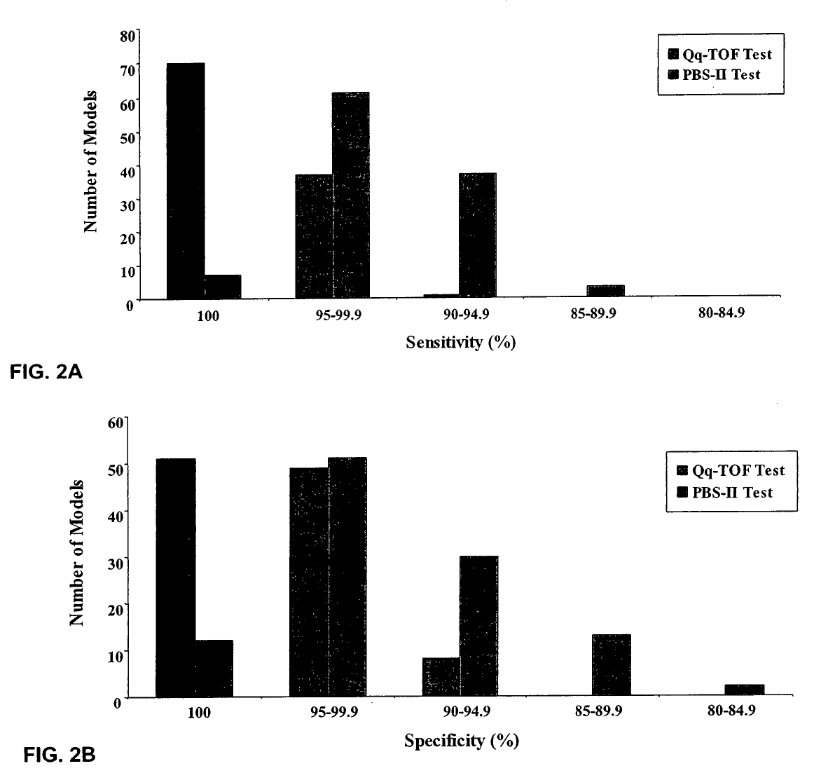

The training set was comprised of serum from 28 unaffected women and 56 women with ovarian cancer. The training and testing set mass spectra were analyzed by the bioinformatic algorithm to generate a series of models under the following set modeling parameters: a) a similarity space of 85%, 90%, or 95% likeness for cluster classification; b) a feature set size of 5, 10, or 15 random m/z values whose combined intensities comprise each pattern; and c) a learning rate of 0.1%, 0.2%, or 0.3% for pattern generation by the genetic algorithm. Four sets of randomly generated models for each of the 27 permutations were derived and queried with the same test set. Sensitivity and specificity testing results for each of the 108 models (four rounds of training for each of the 27 permutations) were generated, as shown in FIGS. 2A and 2B. These results demonstrate that the Qq-TOF MS data produced better results than the lower resolution spectra (P<0.00001, using the exact Cochran-Armitage test (see Agresti A. Categorical Data Analysis New York: John Wiley and Sons (1990)) for trend) throughout a range of modeling conditions.

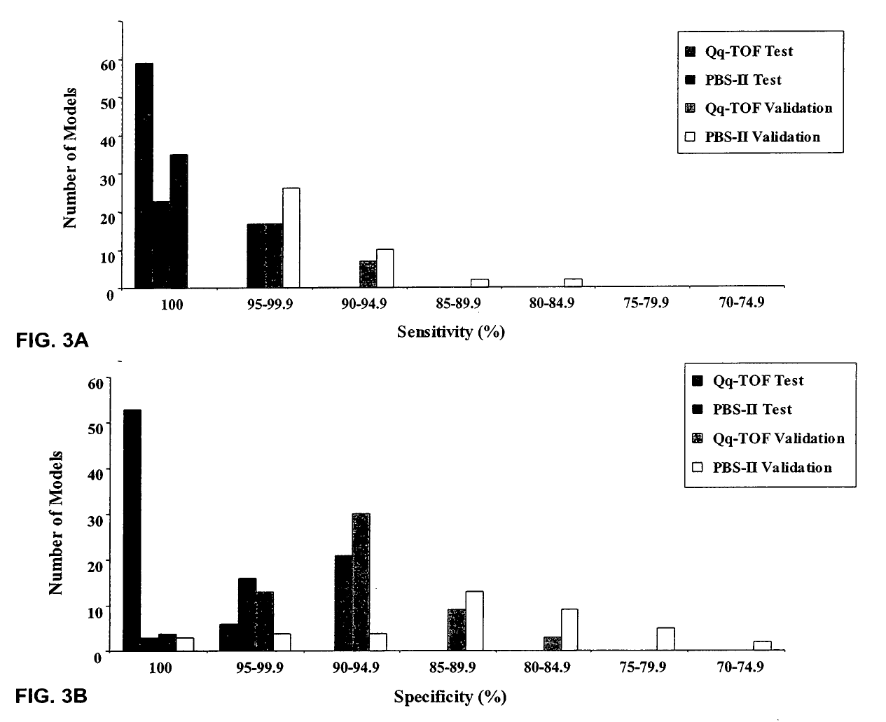

The ability to generate the best performing models for testing and validation was statistically evaluated as multiple models were generated and ranked using the entire range of the modeling parameters above. Models from the training set were validated using a testing set consisting of 31 unaffected and 63 ovarian cancer serum samples. To further validate the ability to diagnose ovarian cancer, a set of blinded sample mass spectra consisting of an additional 37 normal and 40 ovarian cancer serum mass spectra were tested against the model found in training previously discussed. As shown in FIGS. 3A and 3B, the results show the ability of the mass spectra from the higher resolution Qq-TOF MS to generate statistically significant (P<0.00001) superior models over the lower resolution PBS-II mass spectra.

Fifteen models were found that were 100% sensitive in their ability to correctly discriminate unaffected women from those suffering from ovarian cancer, that were 100% specific in discriminating women in the test set, and at least 97% specific in the validation set. These models are shown in Appendix A, and identified as Model 1 through Model 15. Of these models, four were found that were both 100% sensitive and specific for both sets (Models 4, 9, 10, and 15).

Appendix A identifies for each model the following information. First the specificity and sensitivity for each model is shown for the Test set and for the Validity set. The number of samples for which the model correctly grouped women with a “Normal State” (i.e. not having ovarian cancer) and with an “Ovarian Cancer State” is then shown for each of the test and validity tests, compared to the total number of samples in the corresponding sets. For example, in Model 1, the model correctly identified 36 of the 37 women as having a normal state in the Validity set.

Finally, for each model a table is set forth showing the constituent “patterns” comprising the model. Each pattern corresponds to a point, or node, in the N-dimensional space defined by the N m/z values (or “features”) included in the model. Thus, each pattern is a set of features, each feature having an amplitude. Appendix A therefore shows for each model a table containing the constituent patterns, each pattern being in a row identified by a “Node” number. The table also includes columns for the constituent features of the patterns, with the m/z value for each pattern identified at the top of the column. The amplitudes are shown for each feature, for each pattern, and are normalized to 1.0. The remaining four columns in each table are labeled “Count,” “State,” “StateSum,” and “Error.” “Count” is the number of samples in the Training set that correspond to the identified node. “State” indicates the state of the node, where 1 indicates diseased (in this case, having ovarian cancer) and 0 indicates normal (not having the disease). “StateSum” is the sum of the state values for all of the correctly classified members of the indicated node, while “Error” is the number of incorrectly classified members of the indicated node. Thus, for node 5 in Model 1, 13 samples were assigned to the node, whereas 11 samples were actually diseased. StateSum is thus 11 (rather than 13) and Error is 2.

Examination of the key m/z features that comprise the four best performing models (Models 4, 9, 10, and 15) reveals certain features (i.e., contained within m/z bins 7060.121, 8605.678 and 8706.065) that are consistently present as classifiers in those models.

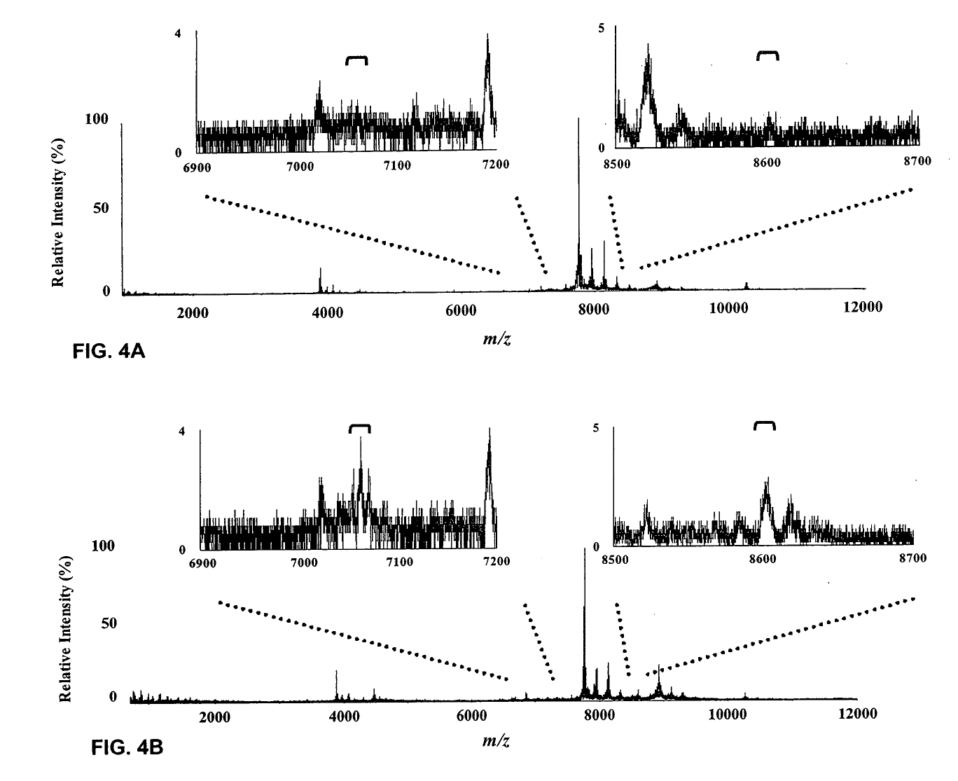

Although the proteomic patterns generated from both healthy and cancer patients using the Qq-TOF MS are quite similar (as seen by comparing FIGS. 4A to 4B), careful inspection of the raw mass spectra reveals that peaks within the binned m/z values 7060.121 and 8605.678 are differentially abundant in a selection of the serum samples obtained from ovarian cancer patients as compared to unaffected individuals and that the features that the ProteomeQuest™ software selected are “real” features and not noise. The insets in FIGS. 4A and 4B show expanded m/z regions highlighting significant intensity differences of the peaks in the m/z bins 7060.121 and 8605.678 (indicated by brackets) identified by the algorithm as belonging to the optimum discriminatory pattern. These results indicate these MS peaks originate from species that may be consistent indicators of the presence of ovarian cancer. The ability to distinguish sera from an unaffected individual or an individual with ovarian cancer based on a single serum proteomic m/z feature alone, however, is not possible across the entire serum study set. While a single key m/z species is insufficient to globally distinguish all of the unaffected and ovarian cancer patients, taken together the combined peak intensities of key ions does allow the two data sets to be completely distinguished.

The four best performing models that are 100% sensitive and specific for the blinded testing and validation tests were chosen for further analysis. Table 1 shows bioinformatic classification results of serum samples from masked testing and validation sets by proteomic pattern classification using the best performing models.

TABLE 1

| | Actual | Predicted (%) |
|---|---|---|
| Benign/Unaffected | 68 | 68 (100) |
| Ovarian Cancer Stage I | 22 | 22 (100) |
| Ovarian Cancer Stage II, III, IV | 81 | 81 (100) |

Each of these models was able to successfully diagnose the presence of ovarian cancer in all of the serum samples from affected women. Further, no false positive or false negative classifications occurred with these best performing models.
Discussion

A limitation of individual cancer biomarkers is the lack of sensitivity and specificity when applied to large heterogeneous populations. Biomarker pattern analysis seeks to overcome the limitation of individual biomarkers. Serum proteomic pattern analysis can provide new tools for early diagnosis, therapeutic monitoring and outcome analysis. Its usefulness is enhanced by the ability of a selected set of features to transcend the biologic heterogeneity and methodological background “noise.” This diagnostic goal is aided by employing a genetic algorithm coupled with a self-organizing cluster analysis to discover diagnostic subsets of m/z features and their relative intensities contained within high-resolution Qq-TOF mass spectral data.

It is believed that diagnostic serum proteomic feature sets exist within constellations of small proteins and peptides. A given signature pattern reflects changes in the physiologic or pathologic state of a target tissue. With regard to cancer markers, it is believed that serum diagnostic patterns are a product of the complex tumor-host microenvironment. It is thought likely that the set of diagnostic features is partially derived from multiple modified host proteins rather than emanating exclusively from the cancer cells. The biomarker profile may be amplified by tumor-host interactions. This amplification includes, for example, the generation of peptide cleavage products by tumor or host proteases. There may exist multiple dependent, or independent, sets of proteins/peptides that reflect the underlying tissue pathology. Hence, the disease related proteomic pattern information content in blood might be richer than previously anticipated. Rather than a single “best” feature set, multiple proteomic feature sets may exist that achieve highly accurate discrimination and hence diagnostic power. This possibility is supported by the data described above.

The low molecular weight serum proteome is an unexplored archive, even though this is the mass region where MS is best suited for analysis. It is thought likely that disease-associated species are comprised of low molecular weight peptide/protein species that vary in mass by as little as a few Daltons. Thus a higher resolution mass spectrometer would be expected to discriminate and discover patterns not resolvable by a lower resolution instrument. The spectra produced by a Qq-TOF MS were compared to that of the Ciphergen PBS-II TOF MS. The routine resolution obtained is in excess of 8000 (at m/z=1500) for the Qq-TOF MS and 150 (at m/z=1500) for the PBS-II TOF mass spectrometer. A SELDI source was used so that both instruments analyzed the same sample on distinct regions of the protein chip array bait surface. While the overall spectral profile is similar, a single peak on the PBS-II TOF MS is resolved into a multitude of peaks on the Qq-TOF MS (seen by comparing FIGS. 1A and 1B to FIGS. 4A and 4B). Moreover, the inherent increase in mass accuracy by higher resolution instrumentation that has uncoupled the mass analyzer from the source will provide for cleaner spectra as this will suppress confounding metastable ions, generate spectra with lower mass drift over time and instruments at the same time as generating more complex, highly resolved data.

In the first phase of comparison, proteomic patterns from mass spectra derived from the same training sets and generated on the high and low-resolution mass spectrometers were scrutinized for their overall sensitivity and specificity over a series of modeling constraints in which patterns were generated using three different degrees of similarity space for the self-organizing clusters to form, three different sets of feature sizes chosen, and three different mutation rates for a total of 27 modeling permutations. Sensitivity and specificity testing results for each of the 108 models (shown in FIGS. 2A and 2B), produced from four rounds of training for each of the 27 permutations, demonstrate that the Qq-TOF MS generated spectra consistently outperformed the lower resolution TOF-MS spectra (P<0.00001) independent of the modeling criteria used.

Since the spectra from the higher resolution platform generate patterns with a higher level of sensitivity and specificity, those spectra could generate more accurate models with a higher degree of sensitivity and specificity—that is, generate the best diagnostic models. These results were generated using even more stringent criteria, in that an additional masked validation set was employed after testing to determine overall accuracy. The higher resolution spectra consistently produced significantly more accurate models as seen in both the testing and validation studies (as shown in FIGS. 3A and 3B). The models derived from the Qq-TOF MS were consistently more sensitive and specific (P<0.00001) than those from the PBS-II TOF MS. Four models were generated that attained 100% sensitivity and specificity in both testing and validation. The number of key m/z values used as classifiers in the four best diagnostic models ranged from 5 to 9. Three m/z bin values were found in two of these four models and two m/z bins were found in three of the four best models. The distinct peaks present in the recurring m/z bins 7060.121, 8605.678 and 8706.065 may be good candidates for low molecular weight components in serum that may be key disease progression indicators.

These data support the existence of multiple highly accurate and distinct proteomic feature sets that can accurately distinguish ovarian cancer. To screen for diseases of relatively low prevalence, such as ovarian cancer, a diagnostic test preferably exceeds 99% sensitivity and specificity to minimize false positives, while correctly detecting early stage disease when it is present. As discussed above, four models generated using high-resolution Qq-TOF MS data achieved 100% sensitivity and specificity. In blinded testing and validation studies any one of these models were used to correctly classify 22/22 stage I ovarian cancer, 81/81 ovarian cancer stage II, III and IV and 68/68 benign disease controls.

Thus, a clinical test could simultaneously employ several combinations of highly accurate diagnostic proteomic patterns arising concomitantly from the same data streams, which, taken together, could achieve an even higher degree of accuracy in a screening setting where a diagnostic test will face large population heterogeneity and potential variability in sample quality and handling. Hence, a high-resolution system, such as the Qq-TOF MS employed in this study, is preferred based on the present results.

Methods

Serum Samples: Serum samples were obtained from the National Ovarian Cancer Early Detection Program (NOCEDP) clinic at Northwestern University Hospital (Chicago, Ill.). Two hundred and forty eight samples were prepared using a Biomek 2000 robotic liquid handler (Beckman Coulter, Inc., Palo Alto, Calif.). All analyses were performed using ProteinChip weak cation exchange interaction chips (WCX2, Ciphergen Biosystems Inc., Fremont, Calif.). A control sample was randomly applied to one spot on each protein array as a quality control for sample preparation and mass spectrometer function. The control sample, SRM 1951A, which is comprised of pooled human sera, was provided by the National Institute of Standards and Technology (NIST).

Sample Preparation: WCX2 ProteinChip arrays were processed in parallel using a Biomek Laboratory workstation (Beckman-Coulter) modified to make use of a ProteinChip array bioprocessor (Ciphergen Biosystems Inc.). The bioprocessor holds 12 ProteinChips, each having 8 chromatographic “spots”, allowing 96 samples to be processed in parallel. One hundred μl of 10 mM HCL was applied to the WCX2 protein arrays and allowed to incubate for 5 minutes. The HCl was aspirated, discarded and 100 μl of distilled, deionized water (ddH₂O) was applied and allowed to incubate for 1 minute. The ddH₂O was aspirated, discarded, and reapplied for another minute. One hundred μl of 10 mM NH₄HCO₃ with 0.1% Triton X-100 was applied to the surface and allowed to incubate for 5 minutes after which the solution was aspirated and discarded. A second application of 100 μL of 10 mM NH₄HCO₃ with 0.1% Triton X-100 was applied and allowed to incubate for 5 minutes after which the ProteinChip array bait surfaces were aspirated. Five μl of raw, undiluted serum was applied to each ProteinChip WCX2 bait surface and allowed to incubate for 55 minutes. Each ProteinChip array was washed 3 times with Dulbecco's phosphate buffered saline (PBS) and ddH₂O. For each wash, 150 μl of either PBS or ddH₂O was sequentially dispensed, mixed by aspirating, and dispensed for a total of 10 times in the bioprocessor after which the solution was aspirated to waste. This wash process was repeated for a total of 6 washes per ProteinChip array bait surface. The ProteinChip array bait surfaces were vacuum dried to prevent cross contamination when the bioprocessor gasket was removed. After removing the bioprocessor gasket, 1.0 μl of a saturated solution of α-cyano-5-hydroxycinnamic acid in 50% (v/v) acetonitrile, 0.5% (v/v) trifluoroacetic acid was applied to each spot on the ProteinChip array twice, allowing the solution to dry between applications.

PBS-II Analysis: ProteinChip arrays were placed in the Protein Biological System II time-of-flight mass spectrometer (PBS-II, Ciphergen Biosystems Inc.) and mass spectra were recorded using the following settings: 195 laser shots/spectrum collected in positive mode, laser intensity 220, detector sensitivity 5, detector voltage 1850, and a mass focus of 6,000 Da. The PBS-II was externally calibrated using the “All-In-One” peptide mass standard (Ciphergen Biosystems, Inc.).

Qq-TOF MS Analysis: ProteinChip arrays were analyzed using a hybrid quadrupole time-of-flight mass spectrometer (QSTAR pulsar i, Applied Biosystems Inc., Framingham, Mass.) fitted with a ProteinChip array interface (Ciphergen Biosystems Inc., Fremont, Calif.). Samples were ionized with a 337 nm pulsed nitrogen laser (ThermoLaser Sciences model VSL-337-ND-S, Waltham, Mass.) operating at 30 Hz. Approximately 20 mTorr of nitrogen gas was used for collisional ion cooling. Each spectrum represents 100 multi-channel averaged scans (1.667 min acquisition/spectrum). The mass spectrometer was externally calibrated using a mixture of known peptides.

Proteomic Pattern Analysis: Proteomic pattern analysis was performed by exporting the raw data file generated from the Qq-TOF mass spectrum into a tab-delimited format that generated approximately 350,000 data points per spectrum. The data files were binned using a function of 400 parts per million (ppm) such that all data files possess identical m/z values (e.g., the m/z bin sizes linearly increased from 0.28 at m/z 700 to 4.75 at m/z 12,000). The intensities in each 400 ppm bin were summed. This binning process condenses the number of data points to exactly 7,084 points per sample. The binned spectral data were separated into approximately three equal groups for training, testing and blind validation. The training set consisted of 28 normal and 56 ovarian cancer samples. The models were built on the training set using ProteomeQues™ (Correlogic Systems Inc., Bethesda, Md.) and validated using the testing samples, which consisted of 30 normal and 57 ovarian cancer samples. The model was validated using blinded samples, which consisted of 37 normal and 40 ovarian cancer samples. These m/z values that were found to be classifiers used to distinguish serum from a patient with ovarian cancer from that of an unaffected individual are based on the binned data and not the actual m/z values from the raw mass spectra.

Statistical significance of the results generated using the Qq-TOF and PBS-II MS was performed using the exact Cochran-Armitage test for trend to compare the distributions of these specificity and sensitivity values between the two instrumental platforms evaluated since the models are constructed independently from each other.

1-5. (canceled)

6. A method of determining whether a biological sample taken from a subject indicates that the subject has a disease by analyzing a data stream that is obtained by performing an analysis of the biological sample, the data stream having a first number of data points, comprising:
condensing the data stream such that the condensed data stream has a second number of data points, the second number being less than the first number of data points;
abstracting the condensed data stream to produce a sample vector that characterizes the condensed data stream in a predetermined vector space containing a diagnostic cluster, the diagnostic cluster being a disease cluster, the disease cluster corresponding to the presence of the disease;
determining whether the sample vector rests within the disease cluster; and
if the sample vector rests within the diseased cluster, identifying the biological sample as indicating that the subject has the disease.

7. The method of claim 6, wherein the indicating that the subject has the disease is highly accurate.

8. The method of claim 7, wherein the data stream is from a mass spectrometer.

9. The method of claim 8, wherein each data point of the data stream includes a m/z value and an associated intensity, the condensing includes using the intensity associated with a plurality of m/z values.

10. The method of claim 9, wherein the condensing is accomplished by binning.

11. The method of claim 7, wherein the disease is cancer.

12. The method of claim 11, wherein the cancer is ovarian cancer.
